(19) United States
(12) Patent Application Publication
(10) Pub. No.: US 2015/0042912 A1
(43) Pub. Date: Feb. 12, 2015

(54) LIQUID CRYSTAL DISPLAY APPARATUS

(71) Applicant: Japan Display Inc., Minato-ku (JP)

(72) Inventors: Emi Higano, Tokyo (JP); Mitsutaka Okita, Tokyo (JP); Daiichi Suzuki, Tokyo (JP); Kazuhiro Nishiyama, Tokyo (JP)

(73) Assignee: Japan Display Inc., Minato-ku (JP)

(21) Appl. No.: 14/455,097

(22) Filed: Aug. 8, 2014

(30) Foreign Application Priority Data
Aug. 12, 2013 (JP) 2013-167464

(51) Int. Cl. G02F 1/1337; G02F 1/1343

(52) U.S. Cl. CPC G02F 1/1337; G02F 1/134309; G02F 2001/133769
USPC 349/41

(57) ABSTRACT

According to one embodiment, a liquid crystal display apparatus includes a first substrate, a second substrate and a liquid crystal layer. The first substrate includes a first electrode, a wall portion, a switching element, a second electrode and a vertical alignment film. The second substrate includes a third electrode and a second vertical alignment film. The second electrode includes a wall electrode provided on a wall electrode formation surface forming a side surface of the wall portion.

### CROSS-REFERENCE TO RELATED APPLICATIONS

This application is based upon and claims the benefit of priority from Japanese Patent Application No. 2013-167464, filed Aug. 12, 2013, the entire contents of which are incorporated herein by reference.

### FIELD

Embodiments described herein relate generally to a liquid crystal display apparatus.

### BACKGROUND

In general, as a display apparatus, a liquid crystal display apparatus is used. A liquid crystal display apparatus required to have a high response speed uses an optically compensated bend (OCB) liquid crystal. In an OCB mode liquid crystal display apparatus, optical compensation film (retardation film) are applied to it cells. Ordinarily, in the OCB mode liquid crystal display apparatus, its initial alignment state is a splay alignment state. It is therefore necessary that the liquid crystal display apparatus is operated after being initially changed from the initial alignment state to a bend alignment state by applying a predetermined voltage. The OCB mode is a mode in which a residual retardation (a retardation of a liquid crystal in a black display) is compensated for by an optical compensation film.

### BRIEF DESCRIPTION OF THE DRAWINGS

FIG. 1 is a schematic view showing a structure of a liquid crystal display apparatus according to a first embodiment;

FIG. 2 is a schematic view showing an equivalent circuit of a liquid crystal display panel as shown in FIG. 1;

FIG. 3 is a plan view enlargedly showing part of an array substrate as shown in FIG. 1 and also showing a single pixel;

FIG. 4 is a cross-sectional view of a liquid crystal display panel, which is taken along line IV-IV in FIG. 3;

FIG. 5 is a cross-sectional view of a structure including first to third electrodes, an insulating layer, a wall portion, alignment films and a liquid crystal layer in the first embodiment, and also a schematic view showing alignment states of liquid crystal molecules in the case where a voltage is applied to the liquid crystal layer;

FIG. 6 is a plan view enlargedly showing part of an array substrate in a liquid crystal display apparatus according to a second embodiment and also showing a single pixel;

FIG. 7 is a cross-sectional view of a liquid crystal display panel, which is taken along line VII-VII in FIG. 6;

FIG. 8 is a cross-sectional view of a structure including first to third electrodes, an insulating layer, stages, wall portions, alignment films and a liquid crystal layer in the second embodiment, and also a schematic view showing alignment states of liquid crystal molecules in the case where a voltage is applied to the liquid crystal layer;

FIG. 9 is a view showing as a graph, a standardized transmittance of the liquid crystal display panel according to the second embodiment, which has a flow effect, and that of a liquid crystal display panel assumed not to have a flow effect;

FIG. 10 is a cross-sectional view of a liquid crystal display panel in a liquid crystal display apparatus according to a third embodiment, and also a view showing first to third electrodes, an insulating layer, stages, wall portions, alignment films and a liquid crystal layer; and

FIG. 11 is a cross-sectional view of a liquid crystal display panel of a liquid crystal display apparatus according to a fourth embodiment, and also a schematic view showing first to third electrodes, an insulating layer, stages, wall portions, alignment films and a liquid crystal layer and further showing alignment states of liquid crystal molecules in the case where a voltage is applied to the liquid crystal layer.

### DETAILED DESCRIPTION

In general, according to one embodiment, there is provided a liquid crystal display apparatus comprising:

a first substrate comprising a first electrode, a first wall, a switching element, a second electrode and a first vertical alignment film, the wall portion including a wall electrode formation surface forming a side surface of the wall portion, the second electrode being electrically connected to the switching element, the first vertical alignment film covering the first electrode, the second electrode and the wall portion;

a second substrate comprising a third electrode and a second vertical alignment film, and located opposite to the first substrate with a gap therebetween, the third electrode being located opposite to the first electrode, the second vertical alignment film covering the third electrode; and

a liquid crystal layer held between the first substrate and the second substrate,

wherein the second electrode includes a wall electrode provided on the wall electrode formation surface.

A liquid crystal display apparatus according to a first embodiment will be explained in detail with reference to the accompanying drawings.

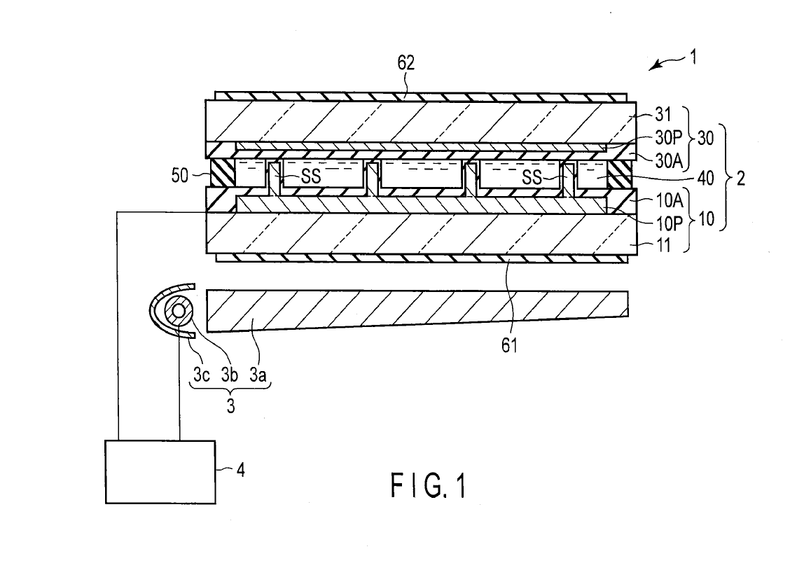

As shown in FIG. 1, a liquid crystal display apparatus 1 comprises a liquid crystal display panel 2, a backlight unit 3 and a controller 4. The liquid crystal display panel 2 comprises an array substrate 10, a counter-substrate 30 located opposite to the array substrate, with a predetermined gap therebetween, and a liquid crystal layer 40 held between the array substrate and the counter-substrate 30. In the first embodiment, the array substrate 10 serves a first substrate, and the counter-substrate 30 serves as a second substrate.

The array substrate 10 comprises a rectangular glass substrate 11 as a transparent insulating substrate. On the glass substrate 11, an array pattern 10P is formed. The array pattern 10P includes a plurality of columnar spacers SS. On the glass substrate 11 and the array pattern 10P, an alignment film 10A is formed.

On the other hand, the counter-substrate 30 comprises a rectangular glass substrate 31 as a transparent insulating substrate. On the glass substrate 31, a counter-pattern 30 is formed. On the glass substrate 31 and the counter-pattern 30P, an alignment film 30A is formed.

The array pattern 10P or the counter-pattern 30P includes color filter CF which will be described later. In the first embodiment, as described later, the counter-pattern 30P includes the color filter CF. The color filter CF includes a plurality of colored layers which are colored red, green and blue.

The gap between the array substrate 10 and the counter-substrate 30 is maintained by the columnar spacers SS. The array substrate 10 and the counter-substrate 30 are joined to each other by a sealing member 50 provided along an outer periphery of a display area. The liquid crystal layer 40 is formed in a space surrounded by the array substrate 10, the counter-substrate 30 and the sealing member 50.

On an outer surface of the array substrate 10, a polarizer 61 is provided. On an outer surface of the counter-substrate 30, a polarizer 62 is provided.

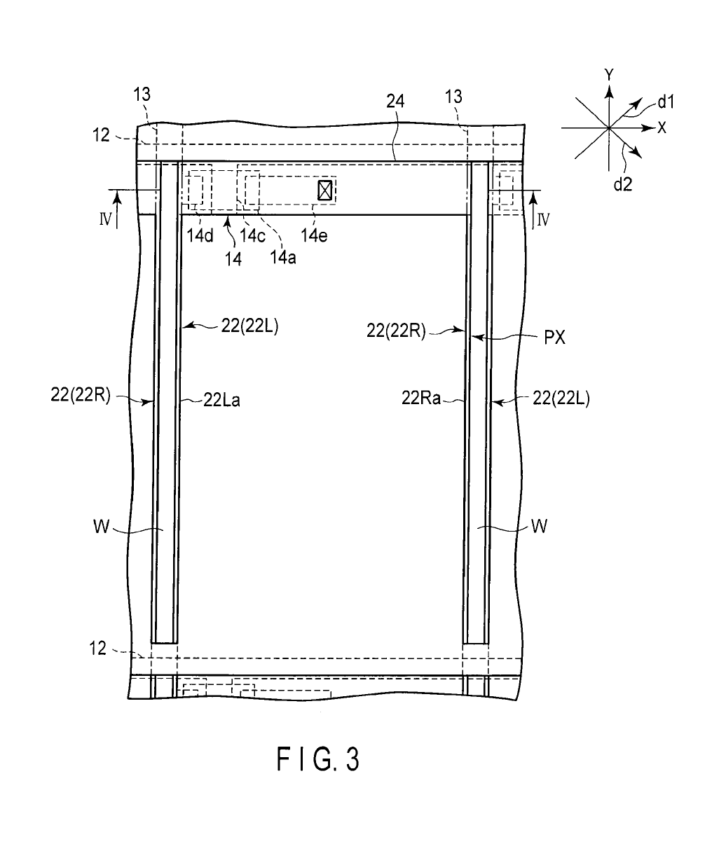

As described later, the polarizer 61 includes a transmission axis parallel to a first direction d1 which crosses a column direction X and a row direction Y at an angle of approximately 45 degrees. The polarizer 62 includes a transmission axis parallel to a second direction d2 perpendicular to the first direction d1. Thus, the polarizeres 61 and 62 are disposed in a cross Nicol arrangement (see FIG. 3).

The backlight unit 3 is provided on an outer surface side of the array substrate 10. The backlight unit 3 includes a light-guiding member 3a, a light source 3b and a reflection plate 3c, the light-guiding member 3a including a light-guiding plate located opposite to the polarizer 61, the light source 3b being located opposite to one of side edges of the light-guiding member 3a.

Next, the liquid crystal display panel 2 will be explained.

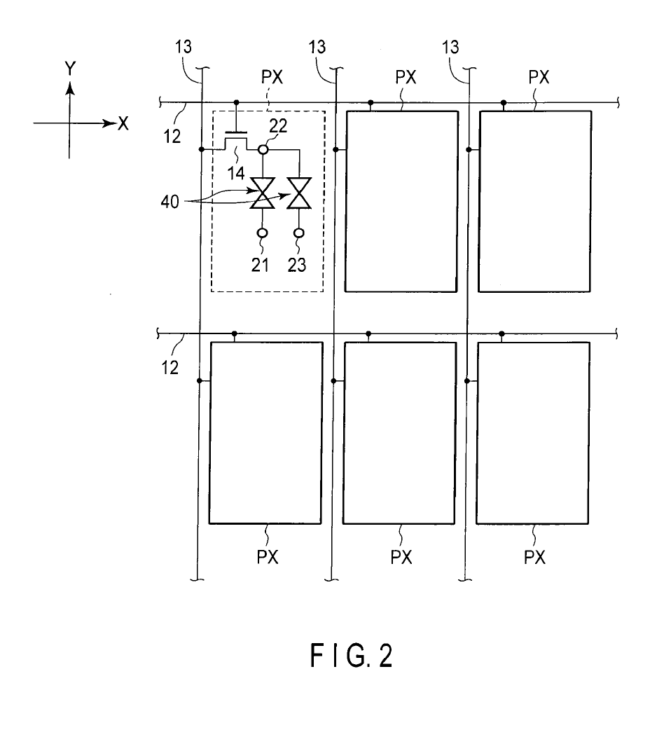

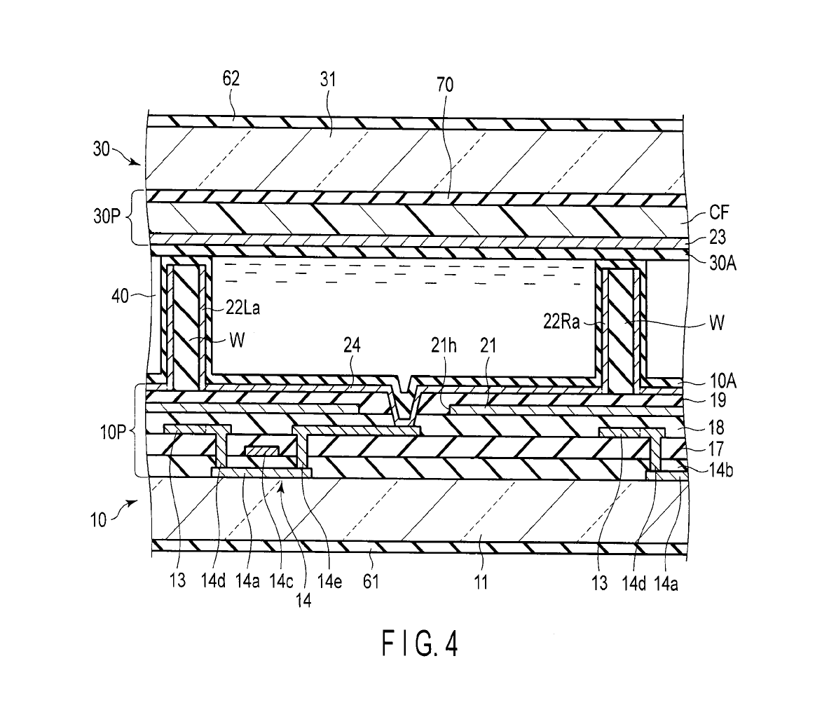

As shown in FIGS. 1 to 4, on the glass substrate 11, a plurality of scanning lines 12 and a plurality of signal lines 13 are provided. The scanning lines 12 are located in parallel with a surface of the glass substrate 11 and extend in the row direction X. The signal lines 13 are located in parallel with the surface of the glass substrate 11 and extend in the column direction Y perpendicular to the row direction X. In the display area, the scanning lines 12 and the signal lines 13 cross each other in a lattice pattern.

As switching elements, for example, thin film transistors (TFTs) 14 are formed close to intersections of the scanning lines 12 and the signal lines 13. The TFTs 14 are formed above the glass substrate 11, and provided in pixels PX, respectively.

The TFTs 14 each comprise a semiconductor layer 14a, a gate insulating film 14b, a gate electrode 14c, a source electrode 14d and a drain electrode 14e. The semiconductor layer 14a is provided above the glass substrate 11. The gate insulating film 14b is provided above the glass substrate 11 and the semiconductor layer 14a. The gate electrode 14c is provided on the gate insulating film 14b, formed to extend from part of an associated one of the scanning lines 12, and located opposite to the semiconductor layer 14a.

The source electrode 14d is provided on an interlayer insulating film 17, and electrically connected to a source region of the semiconductor layer 14a through a contact hole formed in the gate insulating film 14b and the interlayer insulating film 17. The source electrode 14d is connected to an associated one of the signal lines 13. The source electrode 14d is formed integral with the signal line 13.

The drain electrode 14e is formed on the interlayer insulating film 17, and electrically connected to a drain region of the semiconductor layer 14a through a contact hole formed in the gate insulating film 14b and the interlayer insulating film 17. As described later, the drain electrode 14e is connected to a second electrode 22. An insulating layer 18 is provided above the glass substrate 11, the scanning line 12, the signal line 13, the TFT 14 and the interlayer insulating film 17.

On the insulating layer 18, a first electrode 21 is provided. The first electrode 21 is formed of a conductive material (transparent conductive material) having light permeability, e.g., indium tin oxide (ITO). In the first embodiment, the first electrode 21 is a single electrode, provided in the entire display area, and shared with the pixels PX. Thus, the first electrode 21 is a common electrode. Also, the first electrode 21 includes a plurality of opening portions 21h located opposite to the drain electrodes 14e of the TFTs 14. The opening portions 21h are kept electrically insulated from the first electrode 21 and connection electrodes 24 which will be described later.

It should be noted that the first electrode 21 is not limited to the single electrode, and can be variously modified. For example, the first electrode 21 may include a plurality of band-shaped electrodes (electrodes each formed in the shape of a stripe) located apart from areas located opposite to the drain electrodes 14e, extending in the row direction X, arranged apart from each other in the column direction Y, and electrically connected to each other. In this case, the band-shaped electrodes are shared by respective rows of pixels PX arranged in the row direction X.

On the insulating layer 18 and the first electrode 21, an insulating layer 19 is provided. On the insulating layer 19, wall portions W are provided. The wall portions W include wall electrode formation surfaces forming side surfaces of the wall portions W themselves. The wall portions W are formed of insulating material. In the first embodiment, the wall portions W are formed in the shape of a band to linearly extend in the column direction Y, and arranged apart from each other in the row direction X and the column direction Y.

To be more specific, each of the wall portions W is formed in the shape of a band to linearly extend in the column direction Y at a boundary portion between associated two pixels PX adjacent to each other in the row direction X. Each wall portion W is located opposite to and above an associated signal line 13. Also, each wall portion W is shared with the above two pixels PX adjacent to each other in the row direction X.

The wall electrode formation surfaces of the wall portions W are flat and perpendicular to plane surfaces of the glass substrate 11 and the glass substrate 31. It should be noted that from a production viewpoint, if it is hard to precisely form the wall electrode formation surfaces of the wall portions W in the above manner, the wall electrode formation surfaces of the wall portions W may be formed as tapered surfaces which are slightly inclined with respect to a direction perpendicular to the surfaces of the glass substrate 11 and the glass substrate 31. However, in the case where the wall electrode formation surfaces of the wall portions W are formed in the direction perpendicular to the surfaces of the glass substrate 11 and the glass substrate 31, a satisfactory splay alignment can be more easily achieved.

In the first embodiment, the wall portions W are formed to have a great height. Also, the wall portions W form the columnar spacers SS. The heights of the wall portions W are set to cause the wall portions W to maintain a gap between the array substrate 10 and the counter-substrate 30.

As the insulating material of which the wall portions W are formed, although insulating material having light permeability may be applied, insulating material having a light-shielding characteristic may also be applied. This is because in the first embodiment, the wall portions W are provided opposite to the signal lines 13, and in regions located opposite to the signal lines 13, a black display is necessarily provided.

After formation of the wall portions W, the second electrodes 22 and the connection electrodes 24 are formed above the glass substrate 11.

The second electrodes 22 are arranged in a matrix. To be more specific, the second electrodes 22 linearly extend in the column direction Y. In any adjacent two of the pixels PX, second electrodes 22 are separated from each other and electrically insulated from each other.

Each of the pixels PX includes a plurality of second electrodes 22. In the first embodiment, each pixel PX includes two second electrodes 22. To be more specific, the two second electrodes 22 are arranged apart from and in parallel with each other in the row direction X, and located at left and right edge portions of said each pixel PX, respectively. In order that the above two second electrodes 22 be distinguished from each other, the second electrode 22 located on the left side in the figures will be referred to as a second electrode 22L, and the second electrode 22 on the right side in the figures will be as a second electrode 22R.

As described above, the second electrodes 22L and 22R are located on the left and right edge portions of the associated pixel PX, respectively. The second electrode 22L includes a wall electrode 22La, which is provided on a wall electrode formation surface of a wall portion W at the left edge portion of the associated pixel PX. The second electrode 22R includes a wall electrode 22Ra, which is provided on a wall electrode formation surface of a wall portion W at the right edge portion of the associated pixel PX. In the first embodiment, the wall electrodes 22La and 22Ra are provided on the entire wall electrode formation surfaces, respectively.

The connection electrodes 24 are provided on the insulating layer 19, and opposite to the drain electrodes 14e. Also, the connection electrodes 24 are electrically connected to the drain electrodes 14e through contact holes formed in the insulating layer 18 and the insulating layer 19. Furthermore, the connection electrodes 24 are provided at upper end portions of the pixels PX. The connection electrode 24 of one of any adjacent two of the pixels PX is separated from the connection electrode 24 and the second electrode 22 of the other pixel PX.

In the first embodiment, the connection electrodes 24 are formed of the same material as the second electrodes 22L (the wall electrodes 22La) and the second electrodes 22R (the wall electrode 22Ra) and also integral with the second electrodes 22L and the second electrode 22R. Furthermore, the connection electrodes 24 are electrically connected to the second electrodes 22L and the second electrodes 22R. The second electrodes 22 and the connection electrodes 24 are formed of conductive material (transparent conductive material) having light permeability, such as ITO.

It should be noted that the second electrodes 22 and the connection electrodes 24 are not necessarily limited to connection electrodes having light permeability. This is because the connection electrode 24 are provided opposite to a first light-shielding layer 70 which will be described later, and in regions located opposite to the first light-shielding layers 70, a black display is necessarily provided. Thus, as the conductive material of which the second electrodes 22 and the connection electrodes 24 are formed, for example, metal (such as aluminum) may be applied.

As described above, on the glass substrate 11, the array pattern 10P is formed.

On the array pattern 10P, the alignment film 10A is provided. The alignment film 10A covers the first electrode 21, the wall portions W, the second electrodes 22, etc. In the first embodiment, the alignment film 10A is a vertical alignment film.

On the other hand, in the counter-substrate 30, on the glass substrate 31, the first light-shielding layers 70, second light-shielding layers not shown and peripheral light-shielding layer not shown are provided. The first light-shielding layers 70 are formed in the shape of a band and extend in the row direction X. Also, the first light-shielding layers 70 are located opposite to the scanning lines 12 and the connection electrode 24, and cross the signal lines 13. The second light-shielding layer are also formed in the shape of a band to extend in the column direction Y, and located opposite to the signal lines 13. The first light-shielding layers 70 and the second light-shielding layers form a black matrix. The peripheral light-shielding layer is formed in the shape of a rectangular frame, and surrounds an outer periphery of the display area. The peripheral light-shielding layer prevents light from leaking from the outside of the display area.

Above the glass substrate 31, the first light-shielding layers 70, the second light-shielding layers and the peripheral light-shielding layer, color filter CF is provided. The color filter CF comprises colored layers, i.e., layers to which different colors are applied. The colored layers are located in association with the pixels PX, and extend in the column direction Y. To be more specific, with respect to arrangement of the above colored layers, a plurality of groups of colored layers are arranged in the row direction X such that the colored layers of each of the groups have different colors. Peripheral edges of the colored layers are located opposite to the second light-shielding layers (the signal lines 13). For example, the color filter CF comprises red layers, green layers and blue layers.

On the color filter CF, a third electrode 23 is provided. The third electrode 23 is located opposite to the first electrode 21. The third electrode 23 is formed of conductive material having light permeability, such as ITO. In the first embodiment, the third electrode 23 is a single electrode, provided in the entire display area, and shared with the pixels PX. Thus, the third electrode 23 is a common electrode. The first electrode and the third electrode are set to have the same potential.

As described above, on the glass substrate 31, the counter-pattern 30P is formed. On the glass substrate 31 and the counter-pattern 30P, the alignment film 30A is provided. The alignment film 30A covers the third electrode 23, etc. In the first embodiment, the alignment film 30A is a vertical alignment film.

The liquid crystal layer 40 is held between the array substrate 10 and the counter-substrate 30. In the first embodiment, the liquid crystal layer 40 is formed of a positive type liquid crystal material.

It should be noted that the liquid crystal display panel 2 is a normally black mode type of liquid crystal display panel which enters a light-shielding state when a voltage is not applied to a liquid crystal layer 40.

The controller 4 sets potentials of the first electrode 21, the second electrodes 22 and the third electrode 23. For example, the controller 4 sets the potentials of the first electrode 21 and the third electrode 23 to a constant potential such as a ground potential, and controls the TFTs 14 to set the potential of each of the second electrodes 22 to a value independent of that of each of the first electrode 21 and the third electrode 23.

The liquid crystal display apparatus 1 is formed in the above manner.

With no voltage applied between the first electrode 21 and the second electrodes 22 or between the second electrodes 22 and the third electrode 23, the first electrode 21, the second electrodes 22 and the third electrode 23 are set such that they are not given an electric field. With no voltage applied, the alignment directions of liquid crystal molecules do not change from those in their initial state, and thus the initial alignment of the liquid crystal layer 40 is maintained as vertical alignment.

Polarized light of backlight passing through the polarizer 61 is maintained in the liquid crystal layer 40, and is perpendicular to a transmission axis of the polarizer 62. Thus, the probability of passage of polarized light, which is radiated from the liquid crystal layer 40 onto the polarizer 62, through the polarizer 62, (i.e., a transmittance) becomes substantially 0%. The polarizer 62 becomes able to achieve shielding against the polarized light from the liquid crystal layer 40, thus enabling a satisfactory black display to be provided. For the above reason, with no voltage applied, black can be highlighted, as a result of which a higher contrast is obtained.

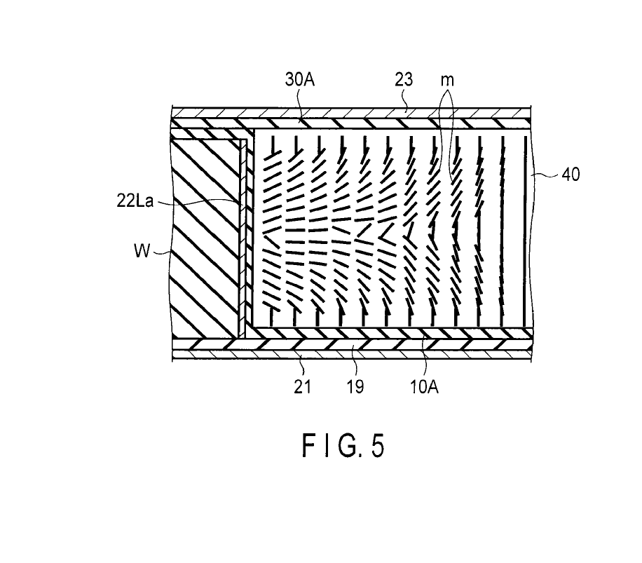

As elements in the liquid crystal display panel 2, FIG. 5 shows only the first electrode 21, the insulating layer 19, the wall portion W, the second electrode 22, the alignment film 10A, the third electrode 23, the alignment film 30A and the liquid crystal layer 40. Also, FIG. 5 shows alignment states of liquid crystal molecules m in the case where a voltage (e.g., 5V) is applied to the liquid crystal layer 40.

As shown in FIG. 5, with a voltage applied between the first electrode 21 and the second electrodes 22 and between the second electrodes 22 and the third electrode 23, the first electrode 21, the second electrode 22 and the third electrode 23 are set to give an electric field. In the voltage applied state, the alignment directions of liquid crystal molecules m vary along an electric flux line from those in their initial state.

Liquid crystal molecules m located close to The wall electrodes 22La and 22Ra and at a center of the liquid crystal layer 40 are aligned substantially horizontally (pretilt angle is substantially zero). Since a larger number of liquid crystal molecules m substantially perpendicular to a normal line are present, they contribute to modulation of polarized light, as a result of the modulation factor can be made higher. Thereby, the contrast characteristic of the liquid crystal display panel 2 can be improved.

Furthermore, liquid crystal molecules m are aligned to have a pretilt angle in which liquid crystal molecules close to the alignment films 10A and 30A are aligned symmetrically with respect to the center of the liquid crystal layer 40. Therefore, in a region of the liquid crystal layer 40, which is located between the first electrode 21 and the third electrode 23, liquid crystal molecules m are aligned in a splay alignment manner. Thus, the liquid crystal display panel 2 can obtain a high-speed responsiveness. From the above, the first electrode 21, the second electrodes 22 and the third electrode 23 are arranged in such a manner as to prevent alignment disorder of liquid crystal molecules m.

The liquid crystal display apparatus having the above structure according to the first embodiment comprises the array substrate 10, the counter-substrate 30 and the liquid crystal layer 40. The array substrate 10 comprises the first electrode 21, the wall portions W including wall electrode formation surfaces, the TFTs 14, the second electrodes 22 (22L, 22R) and the alignment film 10A. The second electrodes 22L include the wall electrodes 22La formed on the wall electrode formation surfaces, and the second electrodes 22R include the wall electrodes 22Ra formed on the wall electrode formation surfaces. The counter-substrate 30 includes the third electrode 23 and the alignment film 30A.

The liquid crystal layer 40 is formed of a positive type liquid crystal material, and the alignment directions of liquid crystal molecules m vary along an electric flux line. With a voltage applied to the liquid crystal layer 40 (at a white display time), in the region of the liquid crystal layer 40 which is located between the first electrode 21 and the third electrode 23, liquid crystal molecules m are aligned in a splay alignment manner. Since the wall electrode formation surfaces of the wall portions W are parallel to a direction perpendicular to plane surfaces of the array substrate 10 and the counter-substrate 30, the liquid crystal layer 40 can achieve a satisfactory splay alignment. Therefore, the liquid crystal display panel 2 can obtain a high-speed responsiveness equivalent to that in an OCB mode in which a bend alignment is achieved.

Furthermore, with no voltage applied to the liquid crystal layer 40 (at a black display time), the alignment of the liquid crystal layer 40 (liquid crystal molecules m) is achieved as vertical alignment. Since the alignment of the liquid crystal layer 40 (liquid crystal molecules m) is not bend alignment as in the OCB mode, a residual retardation (a retardation in liquid crystal in the black display) does not occur. Also, in the black display, black can be highlighted, as a result of which the liquid crystal display apparatus 1 can obtain a high-contrast characteristic.

The liquid crystal display apparatus 1 does not need to compensate for a residual retardation, and can thus be formed without using an optical compensation film (retardation film). Thus, the number of structural elements of the liquid crystal display apparatus 1 can be decreased, and the number of manufacturing steps can also be decreased, as a result of which the manufacturing cost can be lowered.

The wall electrodes 22La and 22Ra are provided opposite to each other in substantially the entire area of the liquid crystal layer 40. The wall electrodes 22La and 22Ra are also provided opposite to each other in also areas other than the center of the liquid crystal layer 40. The alignment directions of liquid crystal molecules m close to the alignment film 10A located opposite to the first electrode 21 and those of liquid crystal molecules m close to the alignment film 30A located opposite to the third electrode 23 can also be controlled. Thereby, the liquid crystal display panel 2 can increase the modulation factor of light (polarized light) at the white display time, as a result of which it can rise the transmittance of light (polarized light) and also the luminance level of a displayed image. From the above also, the liquid crystal display apparatus 1 can obtain a high-contrast characteristic.

The heights of the wall portions W are set such that portions of the alignment film 10A, which are located above the wall portions W, contact the alignment film 30A, and the wall portions W maintain the gap between the array substrate 10 and the counter-substrate 30. Thus, the wall portions W can be used as the columnar spacers SS.

The signal lines 13, which are wiring of the array substrate 10, are located opposite to the wall portions W and below the wall portions W. That is, since the wall portions W are provided above the signal lines 13, lowering of the aperture ratio of the pixels PX can be reduced.

By virtue of the above structure, the liquid crystal display apparatus can achieve a high contrast and a high-speed responsiveness.

Next, a liquid crystal display apparatus according to the second embodiment will be explained. With respect to the second embodiment, the elements having the same functions as those in the first embodiment will be denoted by the same reference numbers and signs as in the first embodiment, and their detail explanations will be omitted. The liquid crystal display apparatus according to the second embodiment can be effectively applied to, e.g., the cases where as described above, it is hard to form wall portions W having a great height, where the wall electrode formation surfaces are tapered to such an extent as to hinder a splay alignment of the liquid crystal layer 40, and where the wall electrodes 22La and 22Ra remain also on the insulating layer 19.

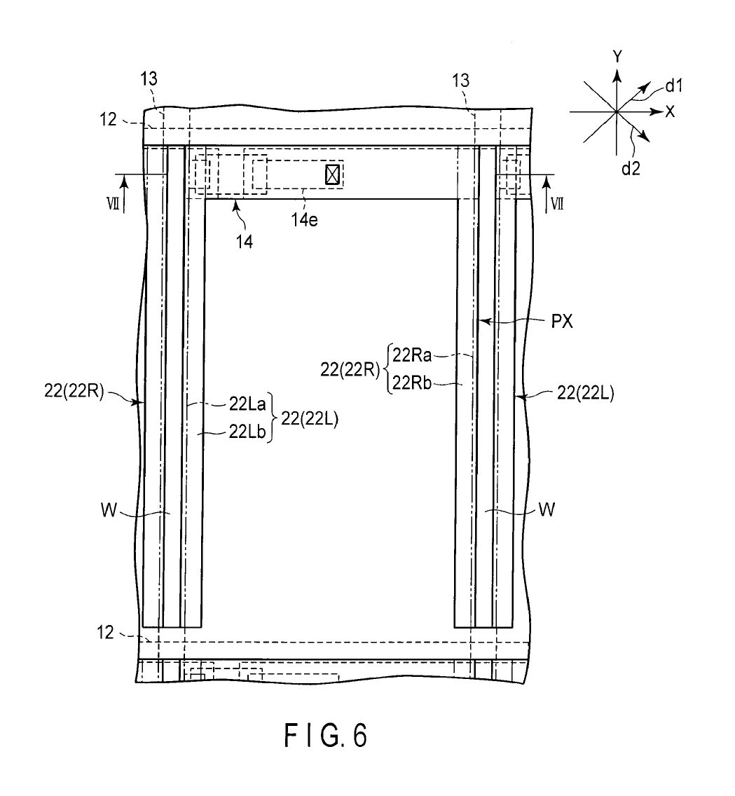

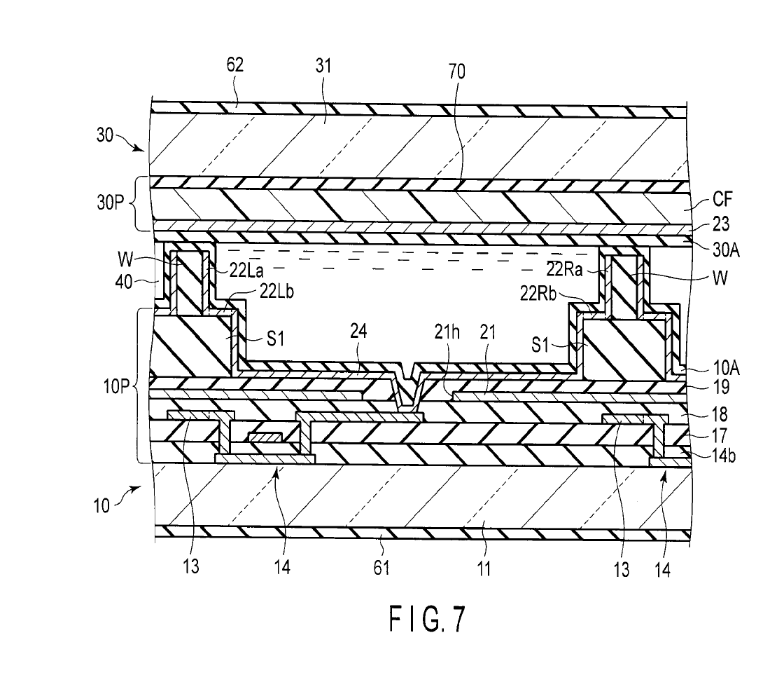

As shown in FIGS. 6 and 7, the array substrate 10 may further include a plurality of stages S1. The stages S1 are formed on the insulating layer 19, and also formed of insulating material. In the second embodiment, the plurality of stages S1 are formed in the shape of a band to linearly extend in the column direction Y, and spaced from each other in the row direction X and the column direction Y.

Stages S1 may be each formed to continuously extend in the column direction Y; i.e., without being divided in the column direction Y. However, since liquid crystal material is easily spread, it is preferable that stages S1 be divided in the column direction, and each stage S1 be formed to linearly extend in the column direction Y, as in the second embodiment. To be more specific, at boundary portions between pixels PX adjacent to each other in the row direction X, the stages S1 are each formed in the shape of a band to linearly extend in the column direction Y. Each of the stages S1 is shared with pixels PX arranged in the row direction X.

The stage S1 includes wall portion formation surface and stage electrode formation surfaces. The wall portion formation surface and the stage electrode formation surfaces form upper surfaces of the stage S1, and are located apart from each other. The width of the upper surface of the stage S1 is greater than width of the wall portion W. The height of the stage S1 is set such that stage electrodes 22Lb and 22Rb, which will be described later, are located at the center of the liquid crystal layer 40 in the thickness direction thereof.

As the insulating material of which the stages S1 are formed, either insulating material having light permeability or insulating material having a light-shielding characteristic can be applied. However, since regions located opposite to the stage electrode formation surfaces have a high modulation factor with respect to polarized light, it is preferable that the stages S1 be formed of insulating material having light permeability.

The wall portion W is provided on the wall portion formation surface of the stage S1. The wall portion W includes wall electrode formation surfaces which form side surfaces of the wall portions W themselves. In the second embodiment, the wall portions W and the stages S1 form the columnar spacers SS. The height of the wall portion W is set such that the stage S1 and the wall portion W maintain the gap between the array substrate 10 and the counter-substrate 30.

The second electrode 22L further includes stage electrode 22Lb. The stage electrode 22Lb is provided on the stage electrode formation surface of the stage S1, and formed integral with the wall electrode 22La. The stage electrode 22Lb is provided only on the stage electrode formation surface (the upper surface of the stage S1); i.e., they are not provided on side surface of the stage S1.

Also, the second electrode 22R further includes stage electrode 22Rb. The stage electrode 22Rb is provided on the stage electrode formation surface of the stages S1, and formed integral with the wall electrode 22Ra. The stage electrode 22Rb is provided only on the stage electrode formation surface (the upper surface of the stage S1); i.e., they are not provided on side surface of the stage S1.

The second electrodes 22 and the connection electrode 24 are formed of conductive material (transparent conductive material) having light permeability, e.g, ITO. It should be noted that as the conductive material of which the second electrodes 22 and the connection electrode 24 are formed, for example, metal (e.g., aluminum) may be applied. However, since regions located opposite to the stage electrodes 22Lb and 22Rb have a high modulation factor with respect to polarized light, it is preferable that the second electrode 22 and the connection electrode 24 be formed of conductive material having light permeability.

The liquid crystal display apparatus 1 is formed in the above manner.

With no voltage applied, alignment of the liquid crystal layer 40 is achieved as vertical alignment.

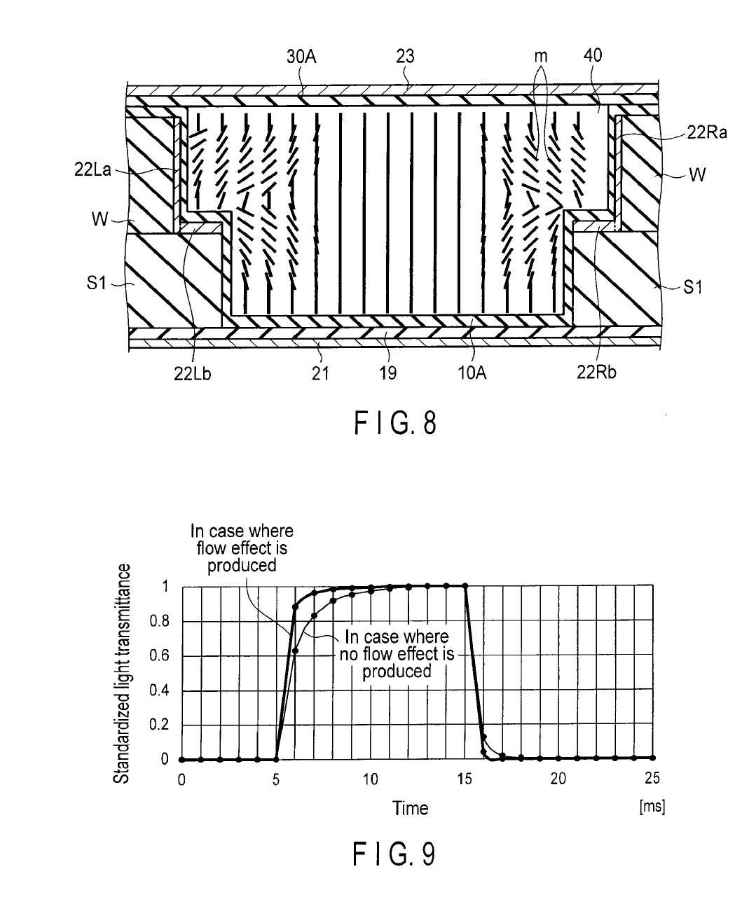

With respect to the liquid crystal display panel 2, FIG. 8 shows only the first electrode 21, the insulating layer 19, the stages S1, the wall portions W, the second electrodes 22, the alignment film 10A, the third electrode 23, the alignment film 30A and the liquid crystal layer 40. FIG. 8 shows alignment states of liquid crystal molecules m in the case where a voltage (e.g., 5V) is applied to the liquid crystal layer 40.

As shown in FIG. 8, with a voltage applied between the first electrode 21 and the second electrodes 22 and between the second electrodes 22 and the third electrode 23, the first electrode 21, the second electrodes 22 and the third electrode 23 are set to give an electric field. In the voltage applied state, the alignment directions of liquid crystal molecules m vary along an electric flux line from those in their initial state.

Liquid crystal molecules m located close to the stage electrodes 22Lb and 22Rb and at the center of the liquid crystal layer 40 are aligned substantially horizontally (the pretilt angle is substantially zero). Furthermore, since the wall electrodes 22La and 22Ra are provided, the number of liquid crystal molecules m substantially perpendicular to the normal line can be increased, as a result of which the liquid crystal molecules m can contribute to modulation of polarized light, and increase the modulation factor, especially the modulation factor of regions located opposite to the stage electrodes 22Lb and 22Rb. Thereby, the contrast characteristic of the liquid crystal display panel 2 can be improved.

Furthermore, the stage electrodes 22Lb and 22Rb are located at the center of the liquid crystal layer 40 in the thickness direction thereof. Liquid crystal molecules m are aligned to have a pretilt angle such that liquid crystal molecules m close to the alignment films 10A and 30A are arranged symmetrically with respect to the center of the liquid crystal layer 40. Thus, in a region of the liquid crystal layer 40, which is located between the first electrode 21 and the third electrode 23, splay alignment is achieved. As a result, the liquid crystal display panel 2 can obtain a high-speed responsiveness. From the above, the first electrode 21, the second electrodes 22 and the third electrode 23 are formed in such a manner as to prevent alignment disorder of liquid crystal molecules m.

As shown in FIG. 9, the liquid crystal display panel 2 according to the second embodiment has a flow effect. It should be noted that FIG. 9 shows a result obtained by performing a simulation with respect to a transmittance (standardized transmittance) of the liquid crystal display panel 2 having a flow effect (standardized transmittance) and that of a liquid crystal display panel assumed not to have a flow effect.

The liquid crystal display panel 2 according to the second embodiment contributes to a high-speed responsiveness as it has a flow effect. The flow effect is caused by alignment of liquid crystal molecules m. Due to the flow effect, when liquid crystal responds, movement of liquid crystal molecules m is further assisted.

According to the liquid crystal display panel having the above structure according to the second embodiment, the array substrate 10 further includes stages S1 provided with stage electrode formation surfaces and wall portion formation surface. The wall portions W are provided on the wall portion formation surfaces of the stages S1. The second electrode 22L further includes stage electrode 22Lb which is provided on the stage electrode formation surface of the stage S1 and formed integral with the wall electrode 22La. The second electrode 22R further includes stage electrode 22Rb which is provided on stage electrode formation surface of the stage S1, and formed integral with the wall electrode 22Ra.

With a voltage applied to the liquid crystal layer 40 (at the white display time), in the region of the liquid crystal layer 40, which is located between the first electrode 21 and the third electrode 23, splay alignment is achieved. Since the heights of the stages S1 are set such that the stage electrodes 22Lb and 22Rb are located at the center of the liquid crystal layer 40 in the thickness direction thereof, the liquid crystal layer 40 can achieve a satisfactory splay alignment. Thus, the liquid crystal display panel 2 can obtain a high-speed responsiveness equivalent to that obtained in an OCB mode in which bend alignment is achieved.

Furthermore, even in the case of providing the stages S1, due to an electric field generated by the second electrodes 22 (the wall electrodes 22La and 22Ra) and the third electrode 23, the alignment directions of liquid crystal molecules m can also be controlled in regions of the liquid crystal layer 40, which are located opposite to the stage electrodes 22Lb and 22Rb. Thereby, the liquid crystal display panel 2 can increase the modulation factor of light (polarized light) at the white display time, and can thus increase the luminance level of a displayed image. From the above also, the liquid crystal display apparatus 1 can obtain a high-contrast characteristic.

With no voltage applied to the liquid crystal layer 40, alignment of the liquid crystal layer 40 is achieved as vertical alignment. Therefore, the liquid crystal display apparatus 1 can obtain a high-contrast characteristic.

The liquid crystal display apparatus 1 does not need to compensate for a residual retardation, and can thus be formed without using an optical compensation film (retardation film). Thus, the number of structural elements of the liquid crystal display apparatus 1 can be decreased, and the number of manufacturing steps can also be decreased, as a result of which the manufacturing cost can be reduced.

The heights of the wall portions W are set such that portions of the alignment film 10A, which are located on the wall portions W, contact the alignment film 30A, and the wall portions W and the stages S1 maintain the gap between the array substrate 10 and the counter-substrate 30. Thus, the stage S1 and the wall portion W, which are formed integral with each other, can be used as the columnar spacer SS.

Moreover, in the second embodiment also, the signal lines 13 are located opposite to the wall portions W and below the wall portions W. Thus, lowering of the aperture ratio of the pixels PX can be prevented.

From the above, the liquid crystal display apparatus can obtain a high-contrast characteristic and a high-speed responsiveness.

Next, a liquid crystal display apparatus according to a third embodiment will be explained. With respect to the third embodiment, elements having the same functions as those in the second embodiment will be denoted by the same numbers and signs as in the second embodiment, and their detailed explanations will be omitted.

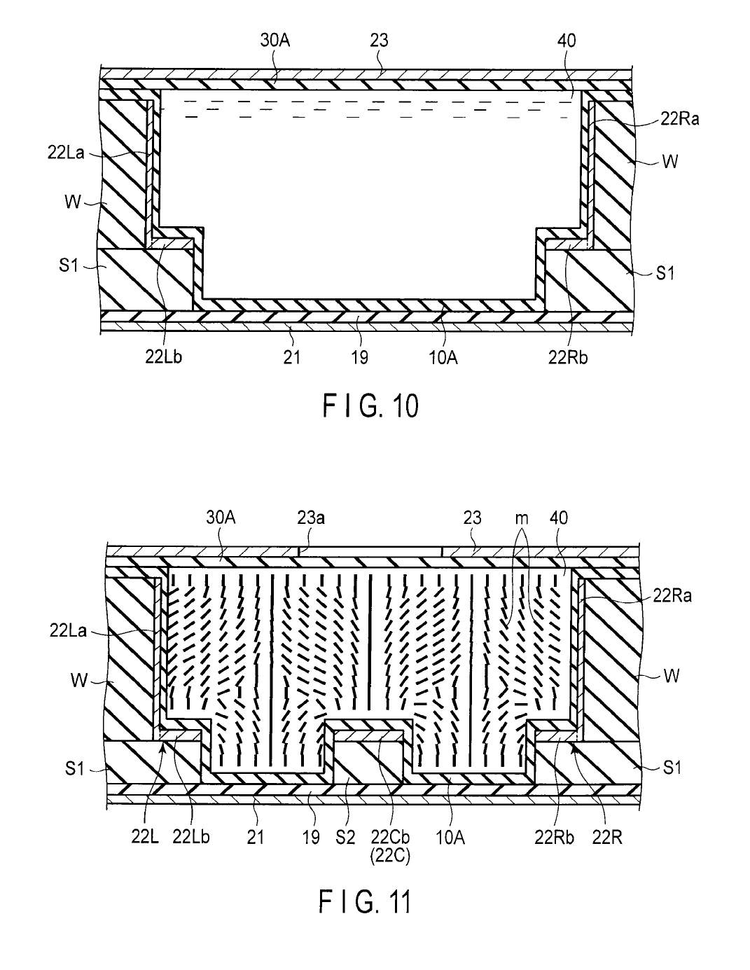

As shown in FIG. 10, the heights of the wall portions W may be set to be greater than those of the stages S1. It should be noted that the stage electrodes 22Lb and the stage electrodes 22Rb are located closer to the first electrode 21 than the center of the liquid crystal layer 40 in the thickness direction thereof.

In the liquid crystal display apparatus 1 according to the third embodiment as described above, the wall portions W are formed to have a greater height than the stages S1. The wall electrodes 22La and 22Ra are located opposite to larger portions of the liquid crystal layer 40 than in the second embodiment. A larger number of crystal molecules m are substantially perpendicular to the normal line than in the second embodiment, and the modulation factor can be increased to a higher value than that in the second embodiment. Thereby, a higher contrast characteristic can be achieved than in the second embodiment.

In the liquid crystal layer 40, splay alignment can be achieved. Thus, the liquid crystal display panel 2 can obtain a high-speed responsiveness.

However, in the third embodiment, since the heights of the wall portions W are set great, the splay alignment of the liquid crystal layer 40 is achieved such that alignment of liquid crystal molecules m on an upper side and that on a lower side are not symmetrical (those in the thickness direction of the liquid crystal layer 40 are not symmetrical). Thus, the response speed is lower than that in the second embodiment. As can be seen from the above, achievement of a higher contrast and that of a higher response speed have a trade-off relationship.

It should be noted that in addition to the above advantages, the liquid crystal display apparatus 1 according to the third embodiment can obtain the same advantages as the liquid crystal display apparatus according to the second embodiment.

By virtue of the above structure, the liquid crystal display apparatus can obtain a high-contrast characteristic and a high-speed responsiveness.

Next, a liquid crystal display apparatus according to a fourth embodiment will be explained. With respect to the fourth embodiment, elements having the same functions as in the third embodiment will be denoted by the same numbers and signs as in the third embodiment, and their detailed explanations will be omitted.

As shown in FIG. 11, the array substrate 10 includes stages S1 as first stages and also stages S2 as second stages. The stages S1 include wall portion formation surfaces and stage electrode formation surfaces (first stage electrode formation surfaces).

The stages S2 are formed of insulating material. In the fourth embodiment, the stages S2 are formed in the shape of a band to linearly extend in the column direction Y, and spaced from each other in the row direction X and the column direction Y. To be more specific, each of the stages S2 is formed in the shape of a band to linearly extend in the column direction Y at a substantially center of an associated pixel PX.

Stages S2 may be each formed to continuously extend in the column direction Y; i.e., without being divided in the column direction. However, since liquid crystal material is easily spread, it is preferable that stages S2 be divided at boundary portions between associated pixels PX to linearly extend in the column direction Y as in the fourth embodiment.

The stages S2 are formed of the same material as the stages S1, and also have the same height as the stages S1. The stages S2 include stage electrode formation surfaces (second stage electrode formation surfaces), which form upper surfaces of the stages S2.

The second electrodes 22 are arranged in a matrix, and formed to linearly extend in the column direction Y. To be more specific, in any adjacent two of the pixels PX, second electrodes 22 are separated from each other and electrically insulated from each other.

Also, each of the pixels PX includes a plurality of second electrodes 22. In the fourth embodiment, each pixel PX includes three second electrodes 22. The three second electrodes 22 are parallelly arranged and spaced from each other in the row direction X; and also located at left and right end portions and a substantially center portion of said each pixel PX, respectively. In the following explanation, in order to distinguish the three second electrodes 22 of each pixel PX from each other, second electrodes located on the left and right sides and the center in the figures are referred to as a second electrode 22L, a second electrode 22R and a second electrode 22C, respectively.

The second electrode 22L includes: a wall electrode 22La formed on a wall electrode formation surface of an associated wall portion W; and a stage electrode (first stage electrode) 22Lb formed on the stage electrode formation surface (first stage electrode formation surface) of an associated stage S1 and integral with the wall electrode 22La.

The second electrode 22R includes: a wall electrode 22Ra provided on a wall electrode formation surface of an associated wall portion W; and a stage electrode (first stage electrode) 22Rb formed on a stage electrode formation surface (first stage electrode formation surface) of an associated stage S1 and integral with the wall electrode 22Ra.

The second electrode 22C includes a stage electrode (second stage electrode) 22Cb, which is provided on a stage electrode formation surface of an associated stage S2. The stage electrode 22Cb (second stage electrode 22C) is formed of the same material and at the same time as the second electrodes 22L and 22R.

In the fourth embodiment, connection electrode 24 is formed as the same material as and integral with the second electrodes 22L, 22R and 22C, and electrically connect the second electrodes 22L, 22R and 22C with each other.

As insulating material of which the stages S1 and S2 are formed, either insulating material having light permeability or insulating material having a light-shielding characteristic can be applied. Also, as conductive material of which the second electrodes 22L, 22R and 22C are formed, either conductive material having light permeability or conductive material having a light-shielding characteristic can be applied. However, since regions located opposite to the stage electrode formation surfaces (the stage electrodes 22Lb and 22Rb, 22Cb) have a high modulation factor with respect to polarized light, it is preferable that the stages S1 and S2 and the second electrodes 22L, 22R and 22C be formed of material having light permeability.

Third electrodes 23 are formed to include slits 23a located opposite to the stage electrodes 22Cb. The slits 23a are arranged in a matrix, and formed in association with the stage electrodes 22Cb to extend in the column direction Y.

The liquid crystal display apparatus 1 having the above structure according to the fourth embodiment is formed in the same manner as that according to the third embodiment, except for addition of the stages S2, the stage electrodes 22Cb and the slits 23a. Therefore, the liquid crystal display apparatus 1 can obtain the same advantages as the liquid crystal apparatus according to the third embodiment.

The liquid crystal display apparatus 1, as described above, further comprises the stages S2, the stage electrodes 22Cb and the slits 23a. Thus, in the liquid crystal layer 40, even if an area is present which an electric field between the first electrode 21 and the second electrodes 22L and 22R or that between the second electrodes 22L and 22R and the third electrode 23 is not applied, an electric field can be applied between the first electrode 21 and the second electrodes 22C or between the second electrodes 22C and the third electrode 23. In regions of the liquid crystal layer 40, which are located opposite to the second electrodes 22C (which are center portions of the pixels PX), polarized light is also modulated, thus contributing to an image display. The number of regions in which polarized light is not modulated can be further decreased. Thereby, the liquid crystal display apparatus 1 can achieve a higher contrast.

By virtue of the above structure, the liquid crystal display apparatus can obtain a high-contrast characteristic and a high-speed responsiveness.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the alignment film 10A and the alignment film 30A may be provided as horizontal alignment films (first and second horizontal alignment films), respectively. For example, in the liquid crystal display apparatus 1 according to the first embodiment, the alignment films 10A and 30A may be provided as horizontal alignment films. In this case, the alignment directions of the alignment films 10A and 30A are parallel to the column direction Y (i.e., parallel to the wall electrode formations surfaces of the wall portions W and also parallel to plane surfaces of the array substrate 10 and the counter-substrate 30). In this case, the transmission axes of the polarizer 61 and the polarizing plate 62 are perpendicular to each other.

Furthermore, the liquid crystal layer 40 may be formed of a negative type liquid crystal material. For example, in the above liquid crystal display apparatus 1 according to the first embodiment, the liquid crystal layer 40 may be formed of a negative type liquid crystal material. In this case, with a voltage applied to the liquid crystal layer 40 (at the white display time), since alignment of the liquid crystal layer 40 is achieved as bend alignment, the liquid crystal display apparatus can obtain a high-contrast characteristic and a high-speed responsiveness.

The liquid crystal display apparatus comprises initial alignment holding means and alignment switching means. The initial alignment holding means includes an alignment film 10A and an alignment film 30A. The initial alignment holding means holds the initial alignment state of the liquid crystal layer 40 in a vertical alignment state. Liquid crystal molecules being in a vertical alignment state have long axes substantially perpendicular to plane surfaces of the array substrate 10 and the counter-substrate 30. Alignment switching means include the above first to third electrodes. The alignment switching means releases the liquid crystal layer 40 from the initial alignment state. The alignment switching means switches the alignment state of the liquid crystal layer 40 to a splay alignment state or a bend alignment state.

The above embodiments are not limited to the above liquid crystal display apparatuses, and can be applied to various types of liquid crystal display apparatuses.

What is claimed is:

1. A liquid crystal display apparatus comprising:
a first substrate comprising a first electrode, a first wall, a switching element, a second electrode and a first vertical alignment film, the wall portion including a wall electrode formation surface forming a side surface of the wall portion, the second electrode being electrically connected to the switching element, the first vertical alignment film covering the first electrode, the second electrode and the wall portion;
a second substrate comprising a third electrode and a second vertical alignment film, and located opposite to the first substrate with a gap therebetween, the third electrode being located opposite to the first electrode, the second vertical alignment film covering the third electrode; and
a liquid crystal layer held between the first substrate and the second substrate,
wherein the second electrode includes a wall electrode provided on the wall electrode formation surface.

2. The liquid crystal display apparatus of claim 1, wherein
part of the first vertical alignment film, which is located above the wall portion, contacts the second vertical alignment film, and
the wall portion has a height set to maintain the gap.

3. The liquid crystal display apparatus of claim 1, wherein
the wall electrode formation surface is parallel to a direction perpendicular to plane surfaces of the first and second substrates.

4. The liquid crystal display apparatus of claim 1, wherein
the first substrate further comprises a stage including a wall portion formation surface and a stage electrode formation surface, which form an upper surface of the stage,
the wall portion is provided on the wall portion formation surface, and
the second electrode further includes a stage electrode formed on the stage electrode formation surface and integral with the wall electrode.

5. The liquid crystal display apparatus of claim 4, wherein
a height of the stage is set to cause the stage electrode to be located at a center of the liquid crystal layer in a thickness direction of the liquid crystal layer.

6. The liquid crystal display apparatus of claim 4, wherein
the wall portion is formed to have a greater height than the stage.

7. The liquid crystal display apparatus of claim 1, wherein the first substrate further includes a line portion located opposite to the wall portion and below the wall portion.

8. The liquid crystal display apparatus of claim 1, wherein
the first substrate further comprises another second electrode electrically connected to the switching element,
the first electrode and the third electrode are each provided as a single electrode, and set to have the same potential,
the second electrode is separated from the other second element, and
the liquid crystal layer is formed of positive type liquid crystal material.

9. The liquid crystal display apparatus of claim 1, wherein
the first substrate further comprises: a first stage including a wall portion formation surface and a first stage electrode formation surface, which form an upper surface of the first stage, and are separated from each other; and a second stage including a second stage electrode formation surface,
the wall portion is provided on the wall portion formation surface,
the second electrode further includes: a first stage electrode formed on the first stage electrode formation surface and integral with the wall electrode;
and a second stage electrode formed on the second stage electrode formation surface,
the first electrode is a single electrode,
the third electrode is a single electrode provided with a slit located opposite to the second electrode, and is set to have the same potential as the first electrode; and
the liquid crystal layer is formed of positive type liquid crystal material.

10. The liquid crystal display apparatus of claim 9, wherein
the second stage electrode is electrically connected to the wall electrode and the first stage electrode.

11. A liquid crystal display apparatus comprising:
a first substrate;
a second substrate;
a liquid crystal layer held between the first substrate and second substrate;
initial alignment holding means for holding an initial alignment state of the liquid crystal layer in a vertical alignment state, in which liquid crystal molecules have major axes substantially perpendicular to plane surfaces of the first and second substrates; and
alignment switching means for switching an alignment state of the liquid crystal layer to one of a splay alignment state and a bend alignment state to release the liquid crystal layer from the initial alignment state.

12. A liquid crystal display apparatus comprising:
a first substrate which comprises: a first electrode; wall portions including wall electrode formation surfaces forming side surfaces of the wall portions; a switching element; second electrodes electrically connected to the switching element; and a first horizontal alignment film covering the first electrode, the second electrodes and the wall portions;
a second substrate comprising a third electrode located opposite to the first electrode, and a second horizontal alignment film covering the third electrode, and located opposite to the first substrate with a gap therebetween; and
a liquid crystal layer held between the first and second substrates,
wherein the second electrodes are separated from each other, and include wall electrodes provided on the wall electrode formation surfaces,
the first electrode and the third electrode are each provided as a single electrode and are set to have the same potential,
the liquid crystal layer is formed of a positive type liquid material, and
alignment directions of the first and second horizontal alignment films are parallel to the wall electrode formation surfaces and plane surfaces of the first and second substrates.
